(19) United States
(12) Patent Application Publication
(10) Pub. No.: US 2015/0266171 A1
(43) Pub. Date: Sep. 24, 2015

(54) SWITCHING DEVICE FOR USE IN A RATCHET WRENCH

(71) Applicant: Basso Industry Corp., Taichung (TW)

(72) Inventors: Chun-Chi Lai, Taichung (TW); Chien-An Liu, Taichung (TW)

(21) Appl. No.: 14/661,748

(22) Filed: Mar. 18, 2015

(30) Foreign Application Priority Data
Mar. 21, 2014 (TW) 103204890

(51) Int. Cl. B25B 21/00; B25F 5/00; B25B 23/00

(52) U.S. Cl. CPC B25B 21/004; B25B 23/0007; B25F 5/00

(57) ABSTRACT

A switching device includes a flow path unit, a control unit and a valve unit. The flow path unit includes an installation flow path, and a guide flow path communicating with an end portion of the installation flow path. The control unit includes a stem member movable within the installation flow path. The valve unit includes a valve member operable to permit compressed air to flow into the end portion of the installation flow path through the guide flow path or into an opposite end portion of the installation flow path for driving movement of the stem member along the installation flow path.

### CROSS-REFERENCE TO RELATED APPLICATION

This application claims priority of Taiwanese Application No. 103204890, filed on Mar. 21, 2014.

### FIELD

The disclosure relates to a switching device, and more particularly to a switching device for use in a ratchet wrench.

### BACKGROUND

Referring to FIGS. 1 and 2, U.S. Pat. No. 6,640,669 discloses a conventional pneumatic ratchet wrench 1 that includes a wrench body 11, a spindle 12 projecting outwardly from the wrench body 11, a ratchet unit 13 for driving rotation of the spindle 12, and a switching device. The ratchet unit 13 includes a yoke 131 that swings relative to the wrench body 11, a pawl 132 that is pivoted to the spindle 12 and that meshes with the yoke 131 such that the swing movement of the yoke 131 drives the rotation of the spindle 12, and a reverse gear 133 that is rotatable relative to the spindle for switching the pawl 132 between two states. The switch device includes two rack members 14 mounted movably in the wrench body 11, two sliding blocks 15 mounted movably to the wrench body 11 and coupled respectively to the rack members 14, two first resilient members 16 each having opposite ends connected respectively to the wrench body 11 and a respective one of the rack members 14, and a second resilient member 17 having opposite ends connected respectively to the rack members 14.

By pushing either one of the sliding blocks 15, the corresponding rack member 14 is moved to mesh with and to rotate the reverse gear 133 for switching the pawl 132 from one state to another. However, since a force applied to the corresponding rack member 14 needs to overcome the basing force of the second resilient member 17, the basing force of the corresponding first resilient member 16 and a frictional force between the reverse gear 133 and the pawl 132 to drive the rotation of the reverse gear 133, the operation of the one of the sliding blocks 15 is laborious. Moreover, the assembly of the components of the switching device of the conventional pneumatic ratchet wrench 1 is relatively complex.

### SUMMARY

Therefore, an object of the disclosure is to provide a switching device that can overcome at least one of the aforesaid drawbacks associated with the prior art.

According to the disclosure, the switching device is for use in a ratchet wrench. The ratchet wrench includes a wrench body that extends along an X axis, a spindle that projects outwardly from the wrench body, a yoke member that is connected to the wrench body and that swings reciprocally relative to the wrench body for driving rotation of the spindle, a pawl member that is pivoted to the spindle and that is switchable between first and second states such that the yoke member is able to drive the spindle to rotate in two opposite directions, and a reverse gear that is rotatable relative to the spindle for switching the pawl member between the first and second states. The switching device includes a flow path unit, a control unit and a valve unit. The flow path unit is formed in the wrench body, and includes an installation flow path that has opposite first and second end portions, and a guide flow path that communicates fluidly with the second end portion of the installation flow path. The control unit includes a stem member that is partially disposed in and movable along the installation flow path, and a control arm that is coupled to the stem member and that is adapted to be contactable with the reverse gear. The stem member has first and second pushed surfaces that are disposed between the first and second end portions of the installation flow path and that face away from each other. The first pushed surface faces toward the first end portion of the installation flow path. The second pushed surface faces toward the second end portion of the installation flow path. The valve unit includes a valve member that is mounted movably to the wrench body. The valve member is operable to permit compressed air to flow into the first end portion of the installation flow path, such that the compressed air pushes the first pushed surface of the stem member to move the control arm from a first position to a second position so as to drive the reverse gear to rotate in a first direction. The valve member is further operable to permit the compressed air to flow through the guide flow path and into the second end portion of the installation flow path, such that the compressed air pushes the second pushed surface of the stem member to move the control arm from the second position to the first position so as to drive the reverse gear to rotate in a second direction opposite to the first direction.

### BRIEF DESCRIPTION OF THE DRAWINGS

Other features and advantages of the disclosure will become apparent in the following detailed description of the embodiments with reference to the accompanying drawings, of which:

FIG. 1 is a schematic fragmentary sectional view of a conventional pneumatic ratchet wrench disclosed in U.S. Pat. No. 6,640,669;

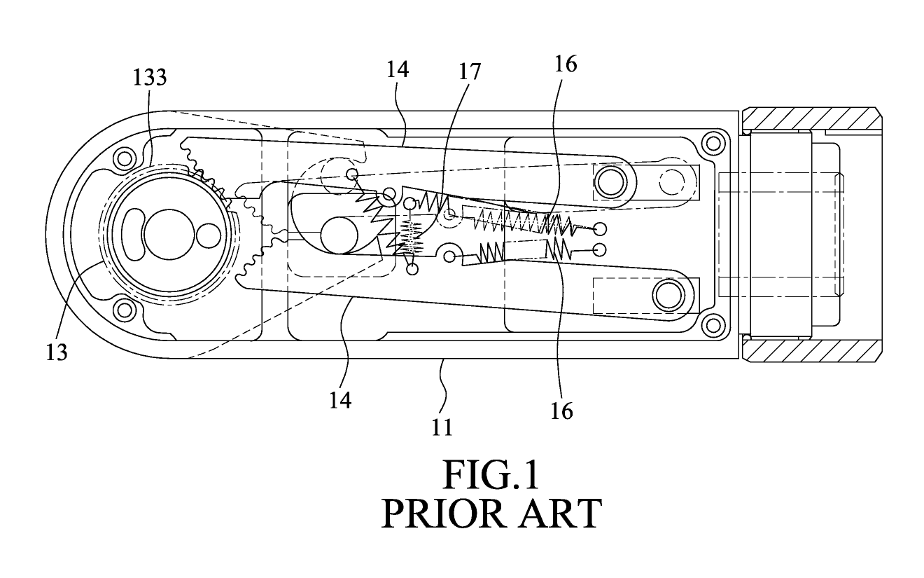

FIG. 2 is a sectional view of the conventional pneumatic ratchet wrench;

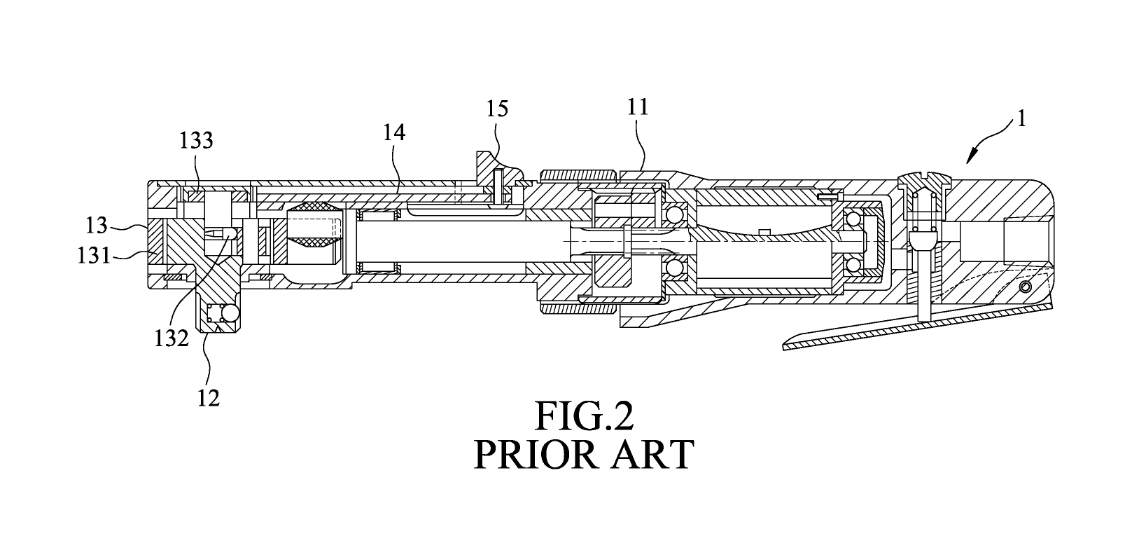

FIG. 3 is a partly exploded perspective view of a ratchet wrench including a first embodiment of a switching device according to the disclosure;

FIG. 4 is a perspective view of the ratchet wrench;

FIG. 5 is a sectional view of the ratchet wrench taken along line V-V in FIG. 4;

FIG. 6 is a sectional perspective view of the ratchet wrench taken along line VI-VI in FIG. 4, illustrating a valve member of the first embodiment at a first position;

FIG. 7 is a sectional view of the ratchet wrench taken along line VII-VII in FIG. 4, illustrating the valve member at the first position;

FIG. 8 is another sectional perspective view of the ratchet wrench, illustrating the valve member at a second position;

FIG. 9 is a fragmentary sectional view of the ratchet wrench, illustrating the valve member at the second position;

FIG. 10 is another fragmentary sectional view of the ratchet wrench, illustrating the valve member at a third position; and

FIG. 11 is a fragmentary sectional view of a ratchet wrench including a second embodiment of the switching device according to the disclosure.

### DETAILED DESCRIPTION

Before the disclosure is described in greater detail, it should be noted that like elements are denoted by the same reference numerals throughout the disclosure.

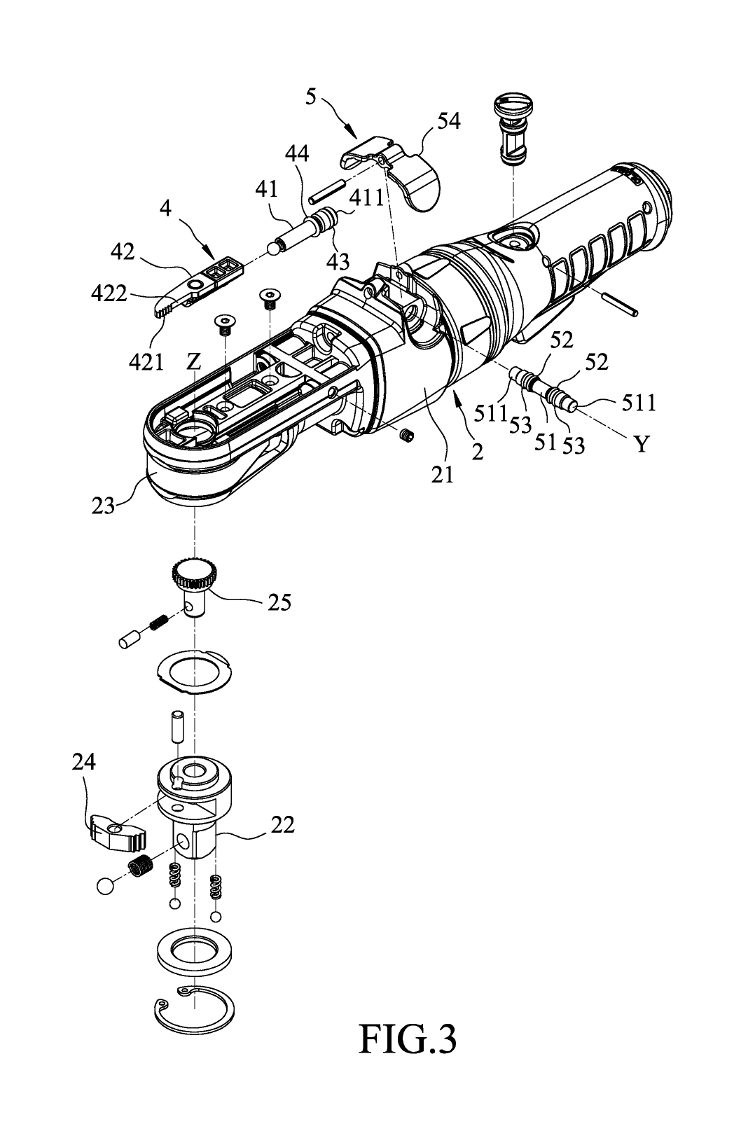

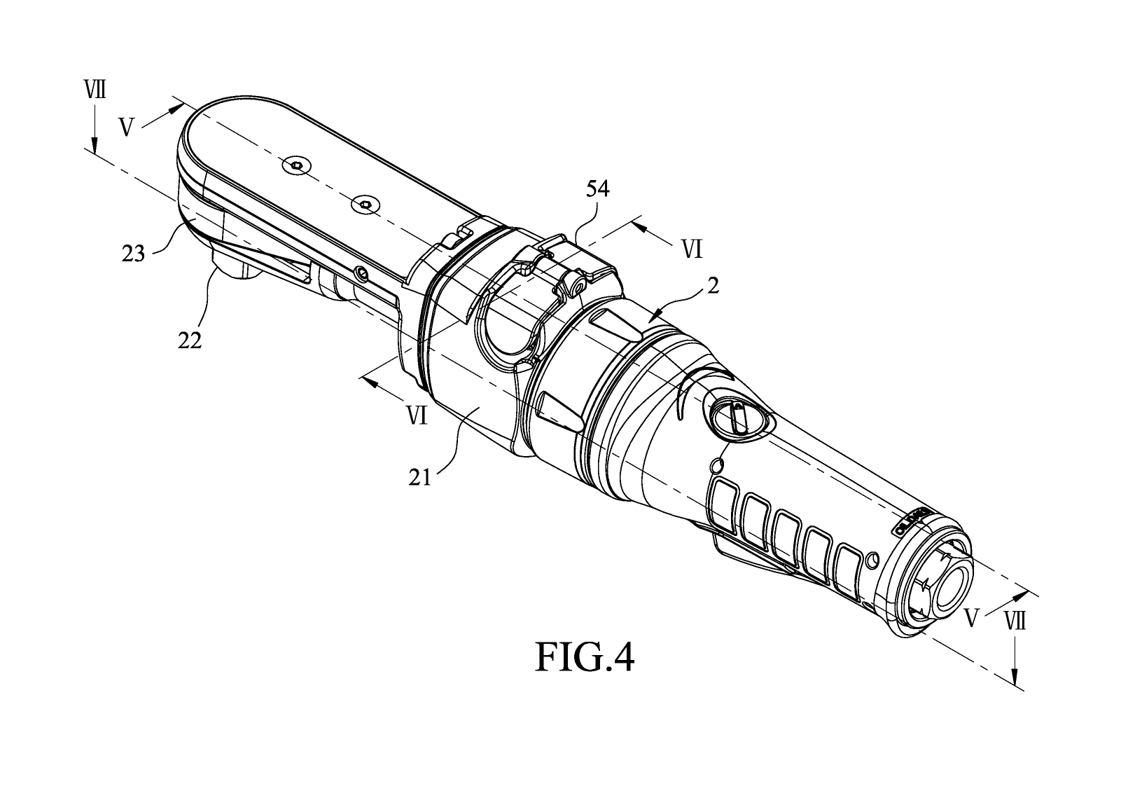

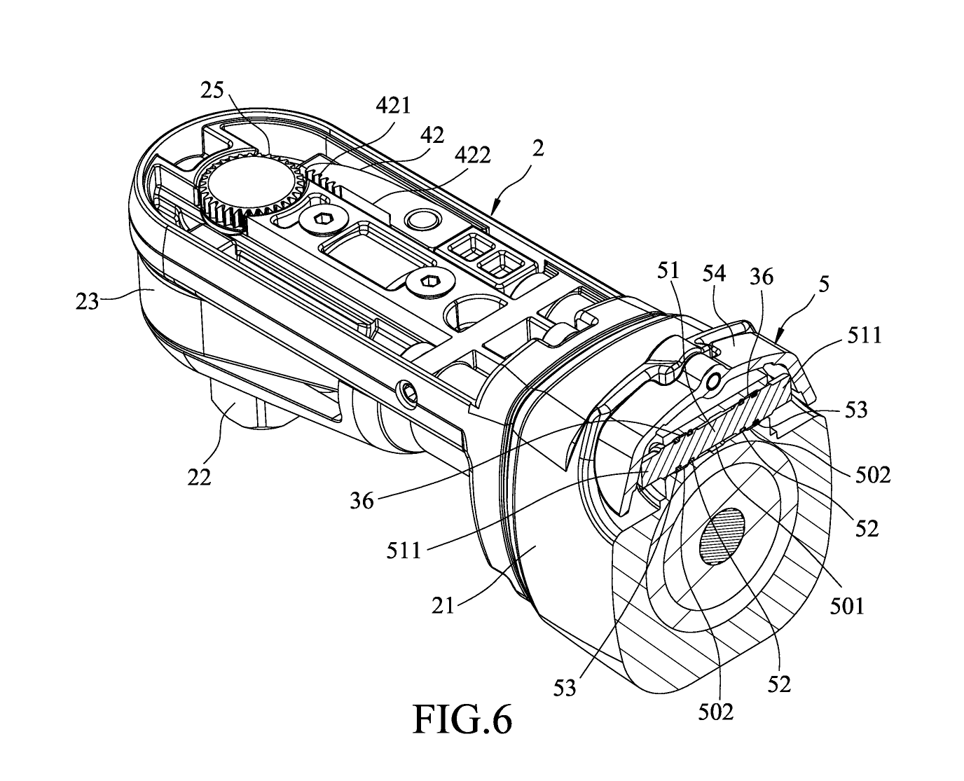

Referring to FIGS. 3 to 7, a first embodiment of a switching device according to the disclosure is for use in a ratchet wrench 2. The ratchet wrench 2 includes a wrench body 21 that extends along an X axis (X), a spindle 22 that projects outwardly from the wrench body 21 and that is rotatable about a Z axis (Z), a yoke member 23 that is connected to the wrench body 21 and that swings reciprocally relative to the wrench body 21 for driving rotation of the spindle 22, a pawl member 24 that is pivoted to the spindle 22 and that is switchable between first and second states such that the yoke member 23 is able to drive the spindle 22 to rotate in two opposite directions, and a reverse gear 25 that is rotatable relative to the spindle 22 about the Z axis (Z) for switching the pawl member 24 between the first and second states. The first embodiment of the switching device includes a flow path unit 3, a control unit 4 and a valve unit 5.

The flow path unit 3 is formed in the wrench body 21, and includes an inlet flow path 31, a main flow path 33, an auxiliary flow path 34, an installation flow path 32, a guide flow path 37 and a communicating flow path 35. The inlet flow path 31 is adjacent to a rear end of the wrench body 21 and extends in the direction of the X axis (X) for guiding compressed air to flow thereinto. The main flow path 33 is operable to communicate fluidly with the inlet flow path 31 for guiding the compressed air to drive the reciprocal swing movement of the yoke member 23. The auxiliary flow path 34 communicates fluidly with the inlet flow path 31. The installation flow path 32 is adjacent to a front end of the wrench body 21, extends in the direction of the X axis (X), and has opposite first and second end portions that are respectively distal from and proximate to the front end of the wrench body 21. The guide flow path 37 is adjacent to the front end of the wrench body 21, and includes a first section 371 that extends in the direction of the X axis (X), and a second section 372 that communicates fluidly the first section 371 and the second end portion of the installation flow path 32. The communicating flow path 35 extends along a Y axis (Y) and communicates fluidly with the auxiliary flow path 34, the installation flow path 32 and the guide flow path 37. In this embodiment, the auxiliary flow path 34 is located between the installation flow path 32 and the guide flow path 37 along the Y axis (Y). The flow path unit 3 further includes two annular grooves 36 that are formed in a path-defining-surface of the wrench body 21 that defines the communicating flow path 35, and that correspond respectively in position to the installation flow path 32 and the guide flow path 37.

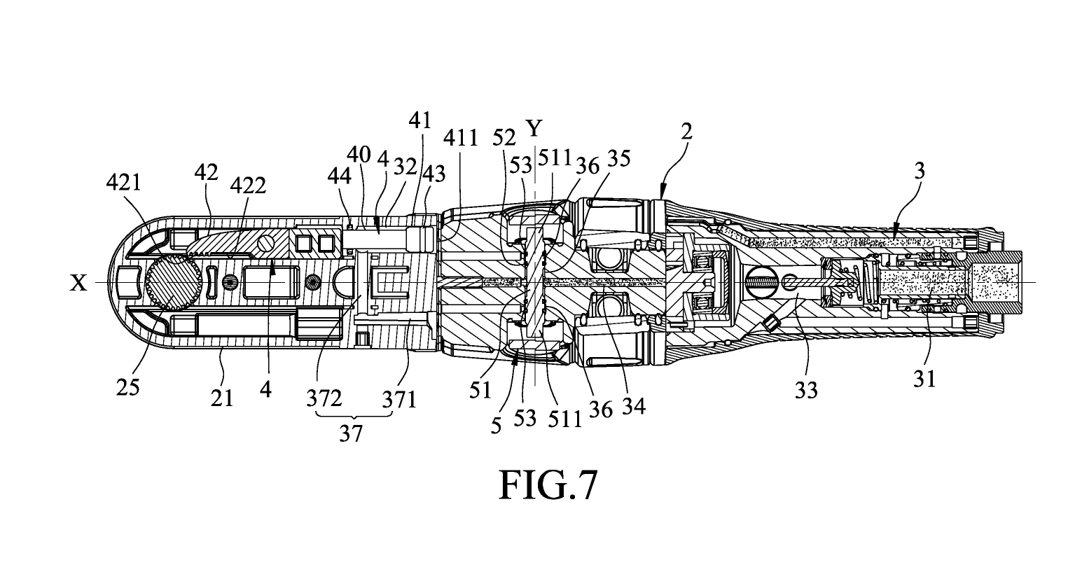

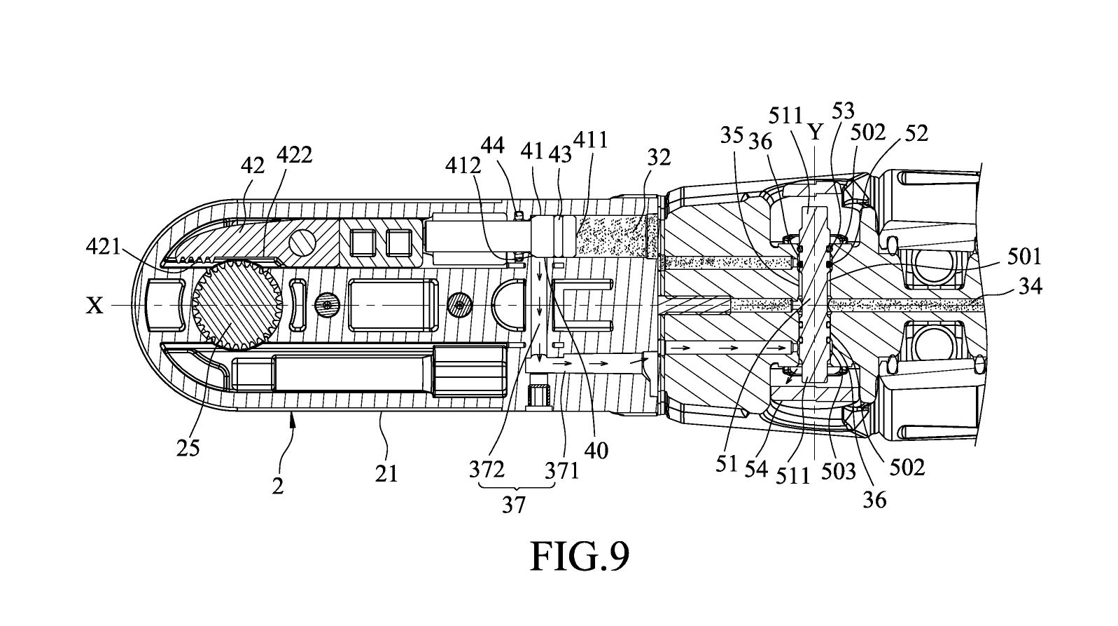

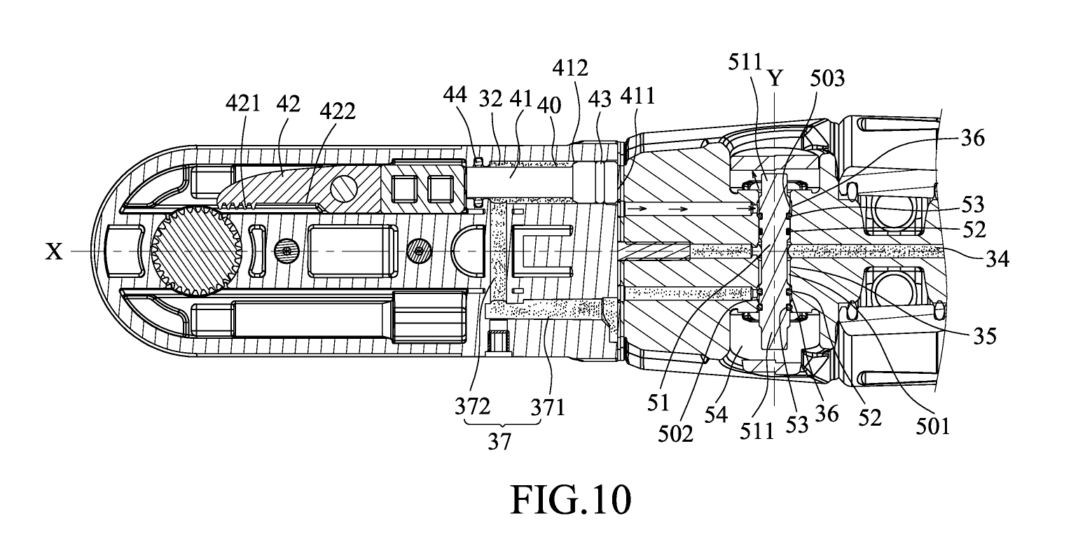

The control unit 4 includes a stem member 41, a control arm 42, a first stem sealing ring 43 and a second stem sealing ring 44. The stem member 41 is partially disposed in and movable along the installation flow path 32, and has first and second pushed surfaces 411, 412 (see FIG. 9) that are disposed between the first and second end portions of the installation flow path 32 and that face away from each other. The first pushed surface 411 faces toward the first end portion of the installation flow path 32. The second pushed surface 412 faces toward the second end portion of the installation flow path 32. The control arm 42 is coupled co-movably to the stem member 41, and is driven by the stem member 41 to move between a first position (see FIGS. 7 and 10) and a second position (see FIG. 9). The control arm 42 has a contact structure 421 that is formed on a side surface thereof and that is contactable with the reverse gear 25, and a recess 422 that is formed in the side surface and that is adjacent to the contact structure 421, such that the reverse gear 25 is spaced apart from a recess-defining surface that defines the recess 422. In this embodiment, the contact structure 421 is configured as a serrated surface portion. The first stem sealing ring 43 is sleeved co-movably on the stem member 41 and is disposed between the first and second pushed surfaces 411, 412 for preventing fluid communication between the first and second end portions of the installation flow path 32. The second stem sealing ring 44 is fixed in the wrench body 21 for extension of the stem member 41 therethrough, and cooperates with the first stem sealing ring 43 to define an annular space 40 therebetween that communicates fluidly with the guide flow path 37.

The valve unit 5 includes a valve member 51, two first valve sealing rings 52, two second valve sealing rings 53 and a press member 54. The valve member 51 is partially disposed in the communicating flow path 32, extends along the Y axis (Y), and has two opposite end portions 511 that are disposed along the Y axis (Y) and that project outwardly from the wrench body 21. The first and second valve sealing rings 52, 53 are sleeved on the valve member 51 and spaced apart from each other. The first valve sealing rings 52 are disposed between the second valve sealing rings 53. The first valve sealing rings 52 cooperatively define a first annular air gap 501 that communicates fluidly with the auxiliary flow path 34. Each of the second valve sealing rings 53 cooperates with an adjacent one of the first valve sealing rings 52 to define a second annular air gap 502 (i.e., there are two second annular air gaps 502 that are respectively disposed at two opposite sides of the first annular air gap along the Y axis). Each of the second annular air gaps 502 communicates fluidly with a respective one of the installation flow path 32 and the guide flow path 37. The press member 54 is pivoted to the wrench body 21 and operable to press either one of the two end portions 511 of the valve member 51 to move the valve member 51 along the Y axis (Y).

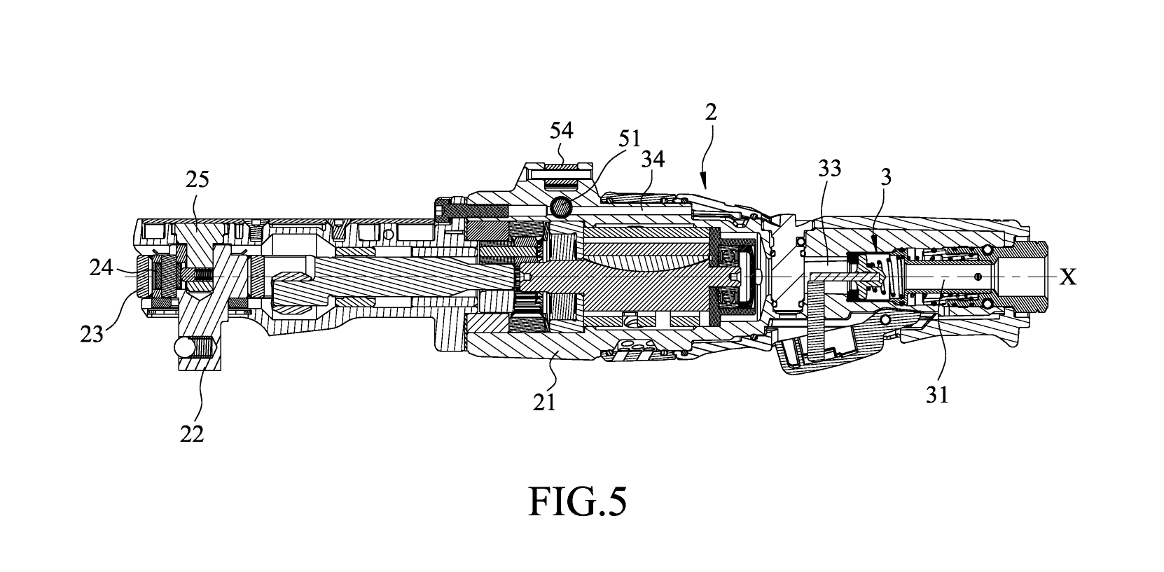

Referring to FIGS. 5 to 7, when the press member 54 is not depressed, the valve member 51 is at a first position, where the first valve sealing rings 52 are located between the annular grooves 36 along the Y axis (Y) and contact air-tightly the path-defining-surface of the wrench body 21, so that fluid communication among the first and second annular air gaps 501, 502 is prevented. That is, the compressed air flowing through the inlet flow path 31 and the auxiliary flow path 34 into the first annular air gap 501 is prevented from flowing into the installation flow path 32 and the guide flow path 37. As such, the control arm 42 is maintained at its original position. When the main flow path 33 is operated to communicate fluidly with the inlet flow path 31, the compressed air flows into a pneumatic motor via the main flow path 33 for driving the reciprocal swing movement of the yoke member 23.

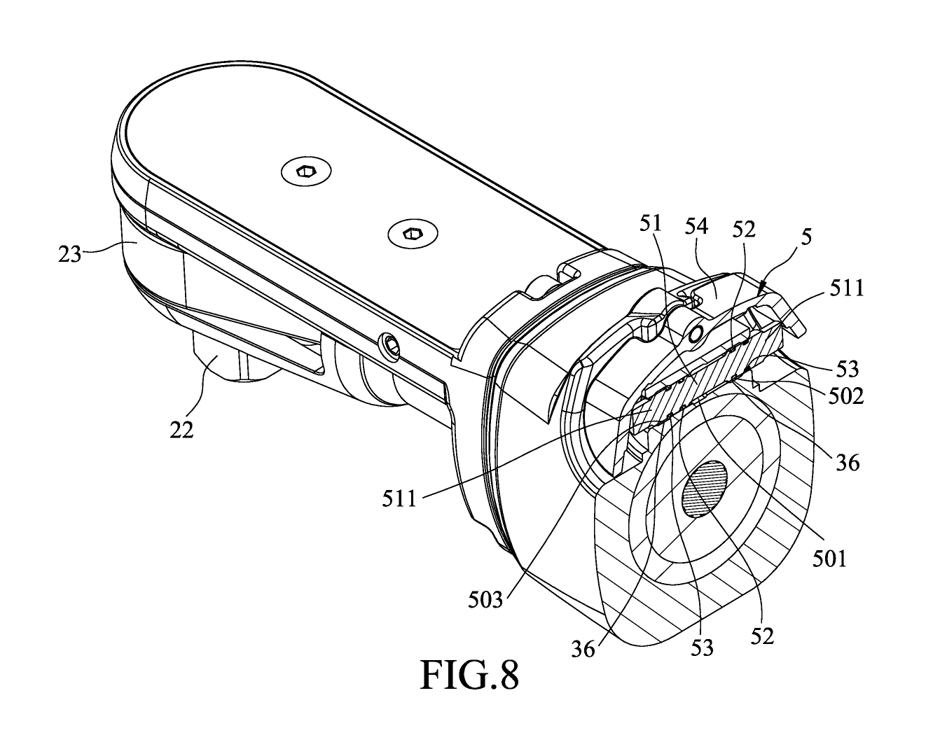

Referring to FIGS. 8 and 9, a side portion of the press member 54 can be depressed to press one of the end portions 511 of the valve member 51 so as to move the valve member 51 from the first position to a second position, where one of the first valve sealing rings 52 proximate to the installation flow path 32 extends into a corresponding annular groove 36 communicating fluidly with the installation flow path 32 and is spaced apart from the path-defining-surface of the wrench body 21, so that fluid communication between the first annular air gap 501 and the second annular air gap 502 that communicates fluidly with the installation flow path 32 is permitted, and where one of the second valve sealing rings 53 that is proximate to the installation flow path 32 contacts air-tightly the path-defining-surface of the wrench body 21 for preventing the compressed air from flowing to the ambiance via a third annular air gap 503 that is located at one side of the one of the second valve sealing rings 53 opposite to the second annular air gap 502 that communicates fluidly with the installation flow path 32. At this time, the fluid communication between the auxiliary flow path 34 and the installation flow path 32 is permitted and the fluid communication between the auxiliary flow path 34 and the guide flow path 37 is prevented. Therefore, the compressed air flowing into the first annular air gap 501 via the auxiliary flow path 34 is permitted to flow into the first end portion of the installation flow path 32, so that the compressed air pushes the first pushed surface 411 of the stem member 41 to move the control arm 42 from the first position to the second position. Hence, the contact structure 421 of the control arm 42 contacts and rotates the reverse gear 25, so as to drive the reverse gear 25 to rotate in a first direction to a first angular position for switching the state of the pawl member 24. Moreover, the air in the annular space 40 is expelled from the wrench body 21 via the guide Flow path 37 and another third annular air gap 503 that is located at one side of the other one of the second valve sealing rings 53 opposite to the second annular air gap 502 that communicates fluidly with the guide flow path 37 for permitting the movement of the stem member 41.

It is noted that by virtue of the recess 422 of the control arm 42, the control arm 42 is spaced apart from the reverse gear 52 after it is moved to the second position (see FIG. 9).

Referring to FIG. 10, another side portion of the press member 54 can be depressed to press the other one of the end portions 511 of the valve member 51 so as to move the valve member 51 from to a third position, where the other one of the first valve sealing rings 52 proximate to the guide flow path 37 extends into a corresponding annular groove 36 communicating fluidly with the guide flow path 37 and is spaced apart from the path-defining-surface of the wrench body 21, so that fluid communication between the first annular air gap 501 and the second annular air gap 502 that communicates fluidly with the guide flow path 37 is permitted, and where the other one of the second valve sealing rings 53 proximate to the guide flow path 37 contacts air-tightly the path-defining-surface of the wrench body 21 for preventing the compressed air from flowing to the ambiance via the third annular air gap 503 that is located at one side of the other one of the second valve sealing rings 53 opposite to the second annular air gap 502 that communicates fluidly with the guide flow path 37. At this time, the fluid communication between the auxiliary flow path 34 and the installation flow path 32 is prevented and the fluid communication between the auxiliary flow path 34 and the guide flow path 37 is permitted. Therefore, the compressed air flowing into the first annular air gap 501 via the auxiliary flow path 34 is permitted to flow into the annular space 40 via the guide flow path 37, so that the compressed air pushes the second pushed surface 412 of the stem member 41 to move the control arm 42 from the second position to the first position for driving the reverse gear 25 to rotate in a second direction opposite to the first direction to a second angular position, so as to switch the state of the pawl member 24. Moreover, the air in the first end portion of the installation flow path 32 is expelled from the wrench body 21 via the third annular air gap 503 that is located at one side of the one of the second valve sealing rings 53 opposite to the second annular air gap 502 that communicates fluidly with the installation flow path 32 for permitting the movement of the stem member 41.

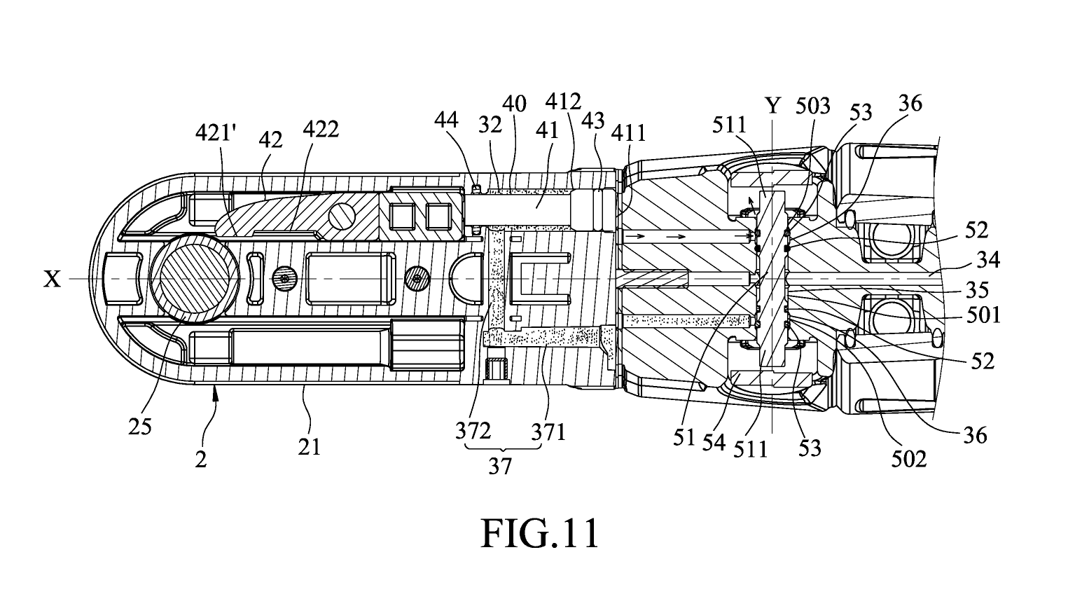

Referring to FIG. 11, a second embodiment of the switching device according to the disclosure is similar to the first embodiment. The difference between the first and second embodiments resides in that the contact structure 421′ of the second embodiment is configured as a rough surface portion for contacting and rotating the reverse gear 25.

The advantages of the disclosure are as follows:

1. By virtue of the configuration of the flow path unit 3, the pawl member 24 can be switched between the first and second states through operation of the valve member 51 solely.

2. The switching device of the disclosure includes relatively few components, and utilizes compressed air to drive the movement of the control arm 42, so that the assembly of the switching device is relatively simple and the operation of the switching device is labor-saving.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A switching device adapted for use in a ratchet wrench, the ratchet wrench including a wrench body that extends along an X axis, a spindle that projects outwardly from the wrench body, a yoke member that is connected to the wrench body and that swings reciprocally relative to the wrench body for driving rotation of the spindle, a pawl member that is pivoted to the spindle and that is switchable between first and second states such that the yoke member is able to drive the spindle to rotate in two opposite directions, and a reverse gear that is rotatable relative to the spindle for switching the pawl member between the first and second states, said switching device comprising:
a flow path unit adapted to be formed in the wrench body, and including an installation flow path that has opposite first and second end portions, and a guide flow path that communicates fluidly with said second end portion of said installation flow path;
a control unit including a stem member that is partially disposed in and movable along said installation flow path, and a control arm that is coupled to said stem member and that is adapted to be contactable with the reverse gear, said stem member having first and second pushed surfaces that are disposed between said first and second end portions of said installation flow path and that face away from each other, said first pushed surface facing toward said first end portion of said installation flow path, said second pushed surface facing toward said second end portion of said installation flow path; and
a valve unit including a valve member that is adapted to be mounted movably to the wrench body, said valve member being operable to permit compressed air to flow into said first end portion of said installation flow path, such that the compressed air pushes said first pushed surface of said stem member to move said control arm from a first position to a second position so as to drive the reverse gear to rotate in a first direction, said valve member being further operable to permit the compressed air to flow through said guide flow path and into said second end portion of said installation flow path, such that the compressed air pushes said second pushed surface of said stem member to move said control arm from the second position to the first position so as to drive the reverse gear to rotate in a second direction opposite to the first direction.

2. The switching device as claimed in claim 1, wherein said installation flow path extends in the direction of the X axis, said guide flow path including a first section that extends in the direction of the X axis, and a second section that communicates fluidly said first section and said second end portion of said installation flow path.

3. The switching device as claimed in claim 2, wherein said control unit further includes first and second stem sealing rings, said first stem sealing ring being sleeved on said stem member and disposed between said first and second pushed surfaces for preventing fluid communication between said first and second end portions of said installation flow path, said second stem sealing ring being adapted to be fixed in the wrench body for extension of said stem member therethrough, and cooperating with said first stem sealing ring to define an annular space therebetween that communicates fluidly with said guide flow path.

4. The switching device as claimed in claim 1, wherein said control arm has a contact structure that is formed on a side surface thereof, and that is adapted to contact and rotate the reverse gear when said control arm is moved from the first position to the second position or when said control arm is moved from the second position to the first position, said contact structure being configured as one of a serrated surface portion and a rough surface portion.

5. The switching device as claimed in claim 4, wherein said control arm further has a recess that is formed in said side surface and that is adjacent to said contact structure, such that the reverse gear is spaced apart from a recess-defining surface that defines said recess.

6. The switching device as claimed in claim 1, wherein said flow path unit further includes an inlet flow path that extends in the direction of the X axis and that is adapted to guide the compressed air to flow thereinto, a main flow path that communicates fluidly with said inlet flow path for guiding the compressed air to drive the reciprocal swing movement of the yoke member, an auxiliary flow path that communicates fluidly with said inlet flow path, and a communicating flow path that extends along a Y axis and that communicates fluidly with said auxiliary flow path, said installation flow path and said guide flow path, said valve member being partially disposed in said communicating flow path, and adapted to be movable relative to the wrench body among a first position where fluid communication between said auxiliary flow path and said installation flow path and fluid communication between said auxiliary flow path and said guide flow path are prevented, a second position where the fluid communication between said auxiliary flow path and said installation flow path is permitted and the fluid communication between said auxiliary flow path and said guide flow path is prevented, and a third position where the fluid communication between said auxiliary flow path and said installation flow path is prevented and the fluid communication between said auxiliary flow path and said guide flow path is permitted.

7. The switching device as claimed in claim 6, wherein: said auxiliary flow path is located between said installation flow path and said guide flow path along the Y axis; said valve unit further includes a plurality of valve sealing rings that are sleeved on said valve member and that are spaced apart from each other; said valve sealing rings cooperatively define a first annular air gap, and two second annular air gaps that are respectively disposed at two opposite sides of said first annular air gap along the Y axis; when said valve member is at the first position, fluid communication among said first and second annular air gaps is prevented; and when said valve member is at the second position or the third position, fluid communication between said first annular air gap and a corresponding one of said second annular air gaps is permitted.

8. The switching device as claimed in claim 7, wherein: said flow path unit further includes two annular grooves that are formed in a path-defining-surface of the wrench body that defines said communicating flow path, and that correspond respectively in position to said installation flow path and said guide flow path; when said valve member is at the first position, two of said valve sealing rings that define said first annular air gap are located between said annular grooves along the Y axis and contact air-tightly the path-defining-surface, so that the fluid communication among said first and second annular air gaps is prevented; and when said valve member is at the second position or the third position, one of the two of said valve sealing rings that define said first annular air gap extends into a corresponding one of said annular grooves and is spaced apart from the path-defining-surface, so that the fluid communication between said first annular air gap and the one of said second annular air gaps is permitted.

9. The switching device as claimed in claim 6, wherein said valve member has two opposite end portions that are disposed along the Y axis and that are adapted to project outwardly from the wrench body.

10. The switching device as claimed in claim 9, wherein said valve unit further includes a press member that is adapted to be pivoted to the wrench body and that is operable to press either one of said two end portions of said valve member to move said valve member among the first, second and third positions.
